(19) United States
(12) Patent Application Publication
(10) Pub. No.: US 2010/0299590 A1
(43) Pub. Date: Nov. 25, 2010

(54) Method and system for processing xml-type telecommunications documents

(75) Inventors: Gregory L. Gissler, Lometa, TX (US); Chris M. Davis, Leander, TX (US); Michael S. Glover, Cedar Park, TX (US)

Correspondence Address: HULSEY IP INTELLECTUAL PROPERTY LAWYERS, P.C., 919 Congress Avenue, Suite 919, AUSTIN, TX, 78701, US

(73) Assignee: Interact Incorporated Software Systems, Lincoln, NE (US)

(21) Appl. No.: 11/547,403

(22) PCT Filed: Mar. 31, 2006
(86) PCT No.: PCT/US06/12105

§ 371 Date: Oct. 2, 2006

(51) Int. Cl. G06F 17/00; G06F 9/45

(52) U.S. Cl. 715/239; 717/144

(57) ABSTRACT

Techniques for use in telecommunications products and services for processing XML-type (e.g., CCXML or VXML) documents in association with the operation of a telecommunications network include parsing a XML-type document a single time for all instruction execution relating to the XML-type document for generating an XML-type reference document. Compiling the XML reference document occurs next for generating a XML-type binary reference file comprising a plurality of binary data sets derived from the XML-type reference document. Then, the method and system convert the XML-type binary reference file to an object tree for use of the contents of the XML-type binary reference file at essentially execution speeds. The method and system provide for storing data in a cache memory, the data relating to the XML-type binary reference file at a point essentially approximating the execution point of the data in the processing of the XML-type document. Furthermore, the method and system execute instructions for the processing of the XML-type document using the data and the XML-type binary reference file.

### FIELD

The disclosed subject matter relates to software products and services. More particularly, this disclosure relates to a novel and improved method and system for processing XML-type documents such as may be used in a telecommunications network, including VoiceXML or VXML documents and CCXML documents, for a wide variety of uses.

### DESCRIPTION OF THE RELATED ART

VXML (VXML) is the World Wide Web Consortium (W3C) standard XML format for specifying interactive voice dialogues between a human and a computer. It is fully analogous to HyperText Markup Language (HTML), which is a markup language designed for the creation of web pages with hypertext and other information to be displayed in a web browser. VXML brings the same advantages of web application development and deployment to voice applications that HTML brings to visual applications. Just as HTML documents are interpreted by a visual web browser, VXML documents are interpreted by a voice browser. VXML applications perform a variety of services, including order inquiry, package tracking, driving directions, emergency notification, wake-up, flight tracking, voice access to email, customer relationship management, prescription refilling, audio newsmagazines, voice dialing, and real-estate information. VXML has tags that instruct the voice browser to provide speech synthesis, automatic speech recognition, dialog management, and sound file playback. Typically, HTTP is used as the transport protocol for fetching VXML pages. While simpler applications may use static VXML pages, nearly all rely on dynamic VXML page generation using an application server like Tomcat, Weblogic, .NET server or WebSphere. In a well-architected web application, the voice interface and the visual interface share the same back-end business logic.

Historically, VXML platform vendors have implemented the standard in different ways, and added proprietary features. But the W3C's new VXML 2.0 standard clarifies most areas of difference, and vendors are going through a rigorous conformance testing process set up by the VXML Forum, the industry group promoting the use of the standard. Two closely related W3C standards used with VXML are the Speech Synthesis Markup Language (SSML) and the Speech Recognition Grammar Specification (SRGS). SSML is used to decorate textual prompts with information on how best to render them in synthetic speech, for example which speech synthesizer voice to use, and when to speak louder. SRGS is used to tell the speech recognizer what sentence patterns it should expect to hear.

The Call Control eXtensible Markup Language (CCXML) is a complementary W3C standard. A CCXML interpreter is used on some VXML platforms to handle the initial call setup between the caller and the voice browser, and to provide telephony services like call transfer and disconnect for the voice browser. CCXML is also very useful in non-VXML contexts. Call Control Extensible Markup Language (CCXML) is an extension of Voice Extensible Markup Language (VXML). Specifically, the CCXML specification provides an asynchronous event interface to start, stop, and monitor VXML document processing. CCXML also provides a robust call control, switching, conferencing, and bridging interface and framework. VXML itself provides none of the above capabilities with the exception of a weak implementation of a bridge call. Attempts to perform conferencing, switching, etc. inside VXML itself yield a presently disclosed XML application that is not portable, does not conform to an accepted specification, and defeats the purpose of moving call flows into VXML.

XML-type documents, like VXML and CCXML documents, have the advantage of being easy to read and write, and, therefore, easy to generate. DTD validation is possible, and there is no operating system dependence when using XML-type documents. Moreover, the software industry generally understands what is meant as an “XML document.”

On the other hand, the use of XML documents for software application also includes certain limitations. For example, XML documents require parsing in order to determine the data and instructions they contain. Also, XML documents rely heavily on JavaScript® as the programming language. Both the parsing operations and the use of JavaScript® are generally processing resources intensive. Unfortunately, in an application requiring continuous, high-speed throughput, these issues can result in a diminished processing capacity. In a telecommunications environment, these limitations are particularly troublesome, because they, very simply, translate into reduced call handling capacity.

Providers of telecommunications software that seek to use XML-type documents for telecommunications applications, have sought to solve the reduced call flow problem through the use of ever increasing amounts of cache memory for call processing applications. However, as the numbers of calls increase, the use of cache memory, together with the requirements for accounting where the cache memory stores specific data or instructions may ultimately exacerbate, rather than solve the problems of processing complexity and, therefore, reduced call throughput.

Accordingly, a need exists for an improved method and system for processing XML-type telecommunications documents, such as VXML documents and CCXML documents for a variety of applications. Such application, necessarily include a broad array of telecommunications applications.

### SUMMARY

Techniques here disclosed provide for processing VXML and CCXML documents that overcome and substantially eliminate existing limitations in the processing of such XML-type documents.

According to one aspect of the disclosed subject matter, there is provided a method and a system for processing XML-type (e.g., CCXML or VXML) documents in association with the operation of a telecommunications network, which method and system provide for parsing an XML-type document a single time for all instruction execution relating to the XML-type document for generating an XML-type reference document, unless a change occurs to the XML-type document. Compiling the XML reference document occurs next for generating a XML-type binary reference file comprising a plurality of binary data sets derived from the XML-type reference document. Then, the method and system convert the XML-type binary reference file to an object tree for use of the contents of the XML-type binary reference file at essentially instruction execution speeds. The method and system provide for storing data in a cache memory, the data relating to the XML-type binary reference file being used at a point essentially approximating the execution point of the data in the processing of the XML-type document. Furthermore, the method and system execute instructions for the processing of the XML-type document using the data and the XML-type binary reference file.

These and other aspects of the disclosed subject matter, as well as additional novel features, may be apparent from the description presented herein. The intent of this summary is not to be a comprehensive description of the claimed subject matter, but rather to present a short overview of some of the subject matter's functionality. Other systems, methods, features and advantages here presented may become apparent to one with skill in the art upon examination of the following FIGUREs and detailed description. It is intended that all such additional systems, methods, features and advantages that are included within this description, be within the scope of the accompanying claims.

### BRIEF DESCRIPTIONS OF THE DRAWINGS

The features, nature, and advantages of the disclosed subject matter may become more apparent from the detailed description set forth below when taken in conjunction with the drawings in which like reference characters identify correspondingly throughout and wherein:

FIG. 1 shows telecommunications network including a prior art interactive voice response (IVR) system;

FIG. 2 conceptually presents one aspect of the disclosed subject matter as an IVR platform;

FIG. 3 conceptually presents a prior art XML-type document processing system;

FIG. 4 illustrates one aspect of the disclosed subject matter as an XML-type document processing system;

FIG. 5 shows a process of the disclosed embodiment for processing CCXML documents;

FIG. 6 depicts a process of the disclosed embodiment for processing VXML documents;

FIG. 7 portrays the entry flow process of the disclosed subject matter as occurs in the CAPER program;

FIG. 8 shows process flow for the start dialog flow process of the present embodiment;

FIG. 9 provides the process flow for creating VXML documents according to the disclosed process;

FIG. 10 shows process flow for the create VXTag Tree process of the disclosed embodiment, as reference in FIG. 9;

FIG. 11 provides a flow diagram of the execute document flow process of the present embodiment;

FIG. 12 shows the end session flow of one embodiment of the disclosed subject matter; and

FIG. 13 illustrates the object linkage for the VXTag tree of one exemplary embodiment of the present disclosure.

### DETAILED DESCRIPTION OF THE SPECIFIC EMBODIMENTS

For the purposes of disclosed the subject matter here presented, applicant provides the following table of definitions of terms and expansion of acronyms which are relevant to obtaining an understanding of the technical description:

| TERM/ | |
|---|---|
| ACRONYM | DEFINITION/EXPANSION |
| API | Application Programming Interface |
| ARCADE | A Resource Centric Architecture in a Distributed |
| | Environment |
| ASCII | American Standard Code for Information Interchange |
| BLOB | Binary Large Object |
| CAPCOM | Call flow Application Compiler |
| CAPER | Call Application Executer |
| CCXML | Call Control eXtensible Markup Language |
| CPU | Central Processing Unit |
| CX | CCXML Proxy program |
| DBM | Database Management Program |
| DIRMA | Distributed Resource Management Architecture |
| DTS | Data Tag Server |
| EACK | Execution Acknowledgment |
| FSD | Functional Specification Document |
| Grammar | a VXML designation of acceptable input |
| HTTP | HyperText Transport Protocol |
| IVR | Interactive Voice Response |
| JSI | JavaScript ® Interface |
| MOAP | Master Of All Processes |
| NEACK | Negative Execution Acknowledgment |
| PSTN | Public Switched Telephone Network |
| RPM | Red Hat Package Manager |
| SAX | Simple API for XML |
| SCIP | Speech Channel Interface Program |
| SCID | Speech Channel Interface Identifier |
| SDD | Software Design Document |
| STATCON | Status and Control |
| TTS | Text To Speech |
| URL | Uniform Resource Locater |
| VOIP | Voice Over Internet Protocol |
| VRU | Voice Response Unit program |
| VXI | VXML Interpreter |
| VXML | Voice eXtensible Markup Language |
| VXRU | VXML Response Unit |
| WebSlinger | Web server file Slinger |
| XML | Extensible Markup Language |
| Xrec | XML record. The format output by the CAPCOM |

The disclosed subject matter presents a method and system processing XML-type documents in a telecommunication network, that overcomes significant limitations and failings in known processes for parsing and executing the contents of such documents in the telecommunications area. For a more complete understanding of the context within which the disclosed subject matter may operate, the following FIGUREs describe a telecommunications system within which one may use the present teachings. In fact, the disclosed subject matter specifically demonstrates utility in the processes for executing instructions appearing in VXML and CCXML documents. Remember, however, that the implementation here described provides but one of a virtually limitless set of applications to which the disclosed subject matter may apply. In fact, although the disclosure focuses on the use of the present method and system for processing XML-type documents, the scope here presented may further include other types of documents or data and instruction formats that, just as do XML-type documents, require parsing and the use of different types of third party applications, as well as other data and instruction formats having structural and functional characteristics similar to those of XML-type documents. Thus, it is not this technical description, but the claims appearing below, which shall set scope of the claimed subject matter.

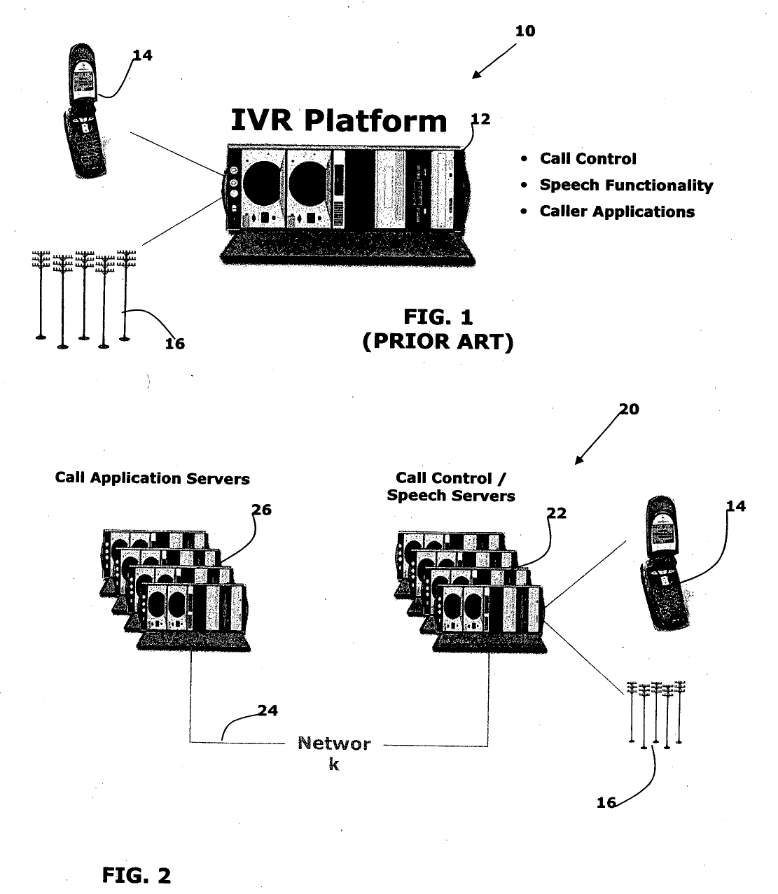

FIG. 1 shows telecommunications network 10 including a prior art interactive voice response (IVR) system 12 for communicating with phone 14, which may be a cellular phone, land-line phone, facsimile machine, or other telecommunications devices 14 for sending and receiving calls via IVR system 12 and a telecommunications network, as represented by network telecommunications hardware 16.

FIG. 2 conceptually presents one aspect of the disclosed subject matter as IVR platform 20 including the features and functions here described. In particular, IVR platform 20 associates call control/speech servers 22 with telecommunication devices 14 and network telecommunications hardware 16. Over a network 24 communications may occur with call application servers 26.

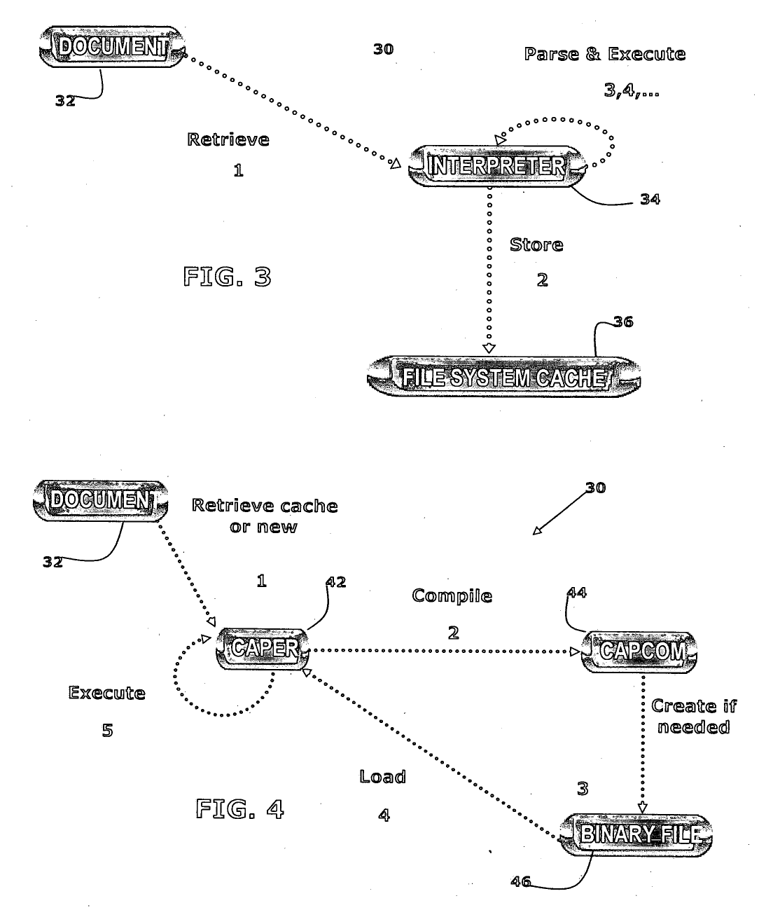

FIG. 3 conceptually presents a prior art XML-type document processing system 30, by which a VXML or CCXML document 32 may be retrieved by interpreter 34. Using a variety of software applications, interpreter 34 may interpret XML-type document 32. Interpreter 34 parses and executes instruction appearing in XML-type document 32. Following the process XML-type document 32 then may be stored in file system cache 36.

FIG. 4 illustrates one aspect of the disclosed subject matter as an XML-type document processing system 40 capable of processing an XML-type document 32. CAPER 42 receives XML-type document 32. From CAPER 42 processing flow continues to CAPCOM 44 for the compilation of the XML-type document 32. If needed, CAPCOM 44 may generate a binary file 46 that is subsequently loaded in a cache for use by CAPER 42. CAPER 42 executes the information appearing in XML-type document 32, making use of binary file 46.

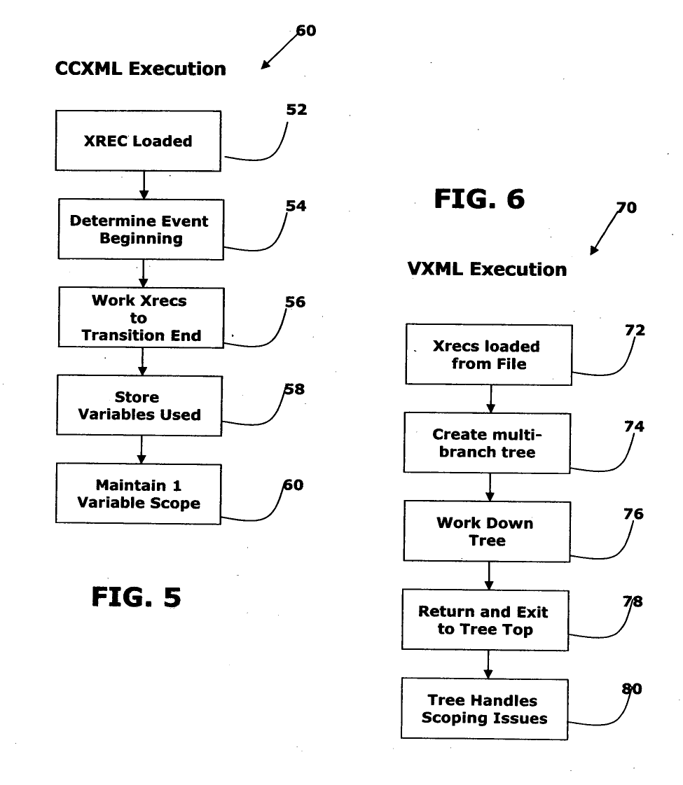

FIG. 5 shows process 50 of the disclosed embodiment for processing CCXML documents. At step 52, Xrecs are loaded from XML-type document file. At step 54, event transitions in the file determine where to begin on specific events. Execution works down Xrecs to the end of a transition at step 56. At step 58, Vtables store all variables used for processing. Also, at step 60, the process has only one variable scope to maintain.

FIG. 6 depicts process 70 if the disclosed embodiment for processing VXML documents. At step 72, Xrecs are loaded from a VXML document for execution. A multi-branched tree of VXTag objects are created from Xrecs at step 74. Execution works down the tree at C++ function call speeds during step 76. Returns and exits work back up the tree at step 78. Also, at step 80, the tree handles advanced scoping issues.

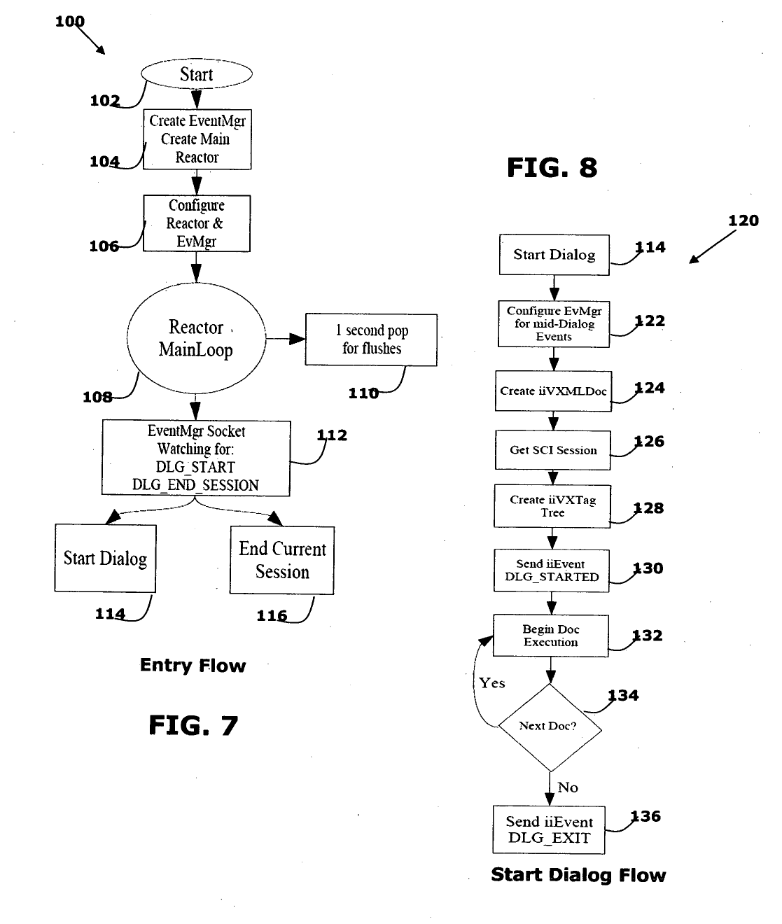

FIG. 7 portrays the entry flow process 100 of the disclosed subject matter as occurs in CAPER 42. In particular, entry flow processing begins at step 102, followed by step 104, wherein occurs the creation of an event manager function and a main reactor function. At step 106, entry flow process configures the reactor and the event manager. The main loop 108 includes step 110 for a 1-second pop for flushes. Following the operations at reactor main loop 108, entry process flow continues to step 112, wherein the event manager socket watches for the dialog start and dialog end events. Upon the occurrence of the dialog start event, entry process flow goes to step 114 for starting a dialog, as depicted below in FIG. 8. At step 116, entry flow process starts the process dialog. Alternatively, if a dialog end event occurs, then process flow continues to end current session step 116.

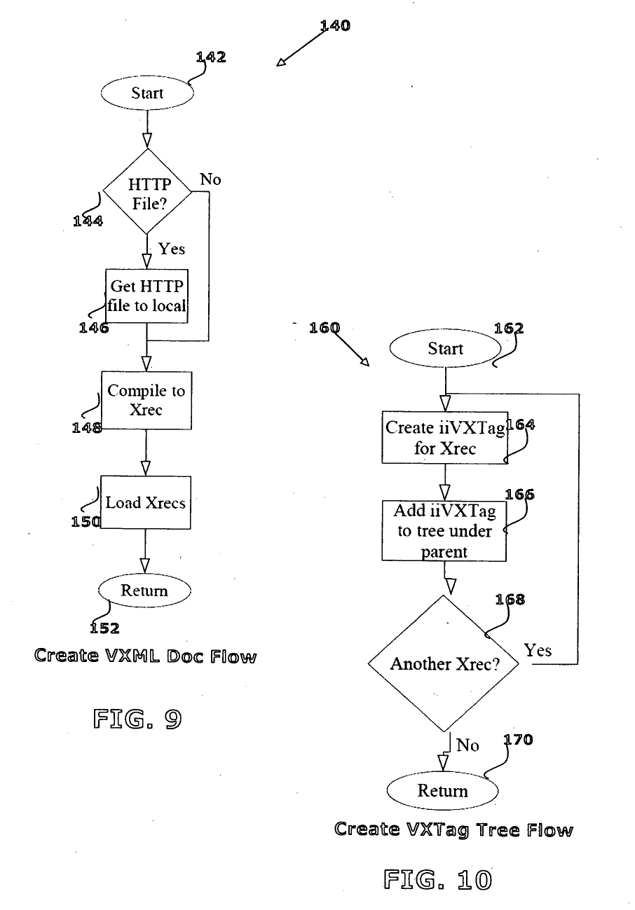

FIG. 8 shows process flow for the start dialog flow process 120 of the present embodiment. Beginning at start dialog step 114, processing continues to configure event manager step 122 for mid-dialog events. At step 124, start dialog flow process creates a VXML document, as described more fully at FIG. 9 below. At step 126, start dialog flow 120 gets an SCI session. Step 128 represents the step of creating a VXML Tag Tree, as described in more detail in FIG. 10 below. Next, at step 130, an event dialog started is sent, so that at step 132, document execution may take place. Query 134 tests whether the next document is to be executed. If so, then processing returns to step 132. Otherwise, at step 136, start dialog flow process continues to step 136 for sending the next dialog exit event.

FIG. 9, as mentioned, provides the process flow 140 for creating VXML documents according to the disclosed process. Process flow 140 begins with start step 142, which permits query 144 to test whether an HTTP file is present. If so, then process flow 140 continues to step 146 for getting the HTTP file to local and then compiling to Xrecs. Otherwise, at step 148 the VXML document is compiled to create Xrecs directly. At step 150, create VXML document flow process 140 loads the created Xrecs into storage at IVR platform 20.

FIG. 10 shows process flow 160 for the create VXTag Tree process of the disclosed embodiment, as reference in FIG. 9. Beginning at step 162, process flow begins, allowing the creation of the VXTag for Xrec at step 164. At step 166, process flow 160 adds the VXTag to the tree under any parent tree that may exist. Testing whether another Xrec exists occurs at step 168. If so, process flow 160 returns to step 164 for further creation of the tree. Otherwise, process flow continues to return step 170 for continuing start dialog flow process 120.

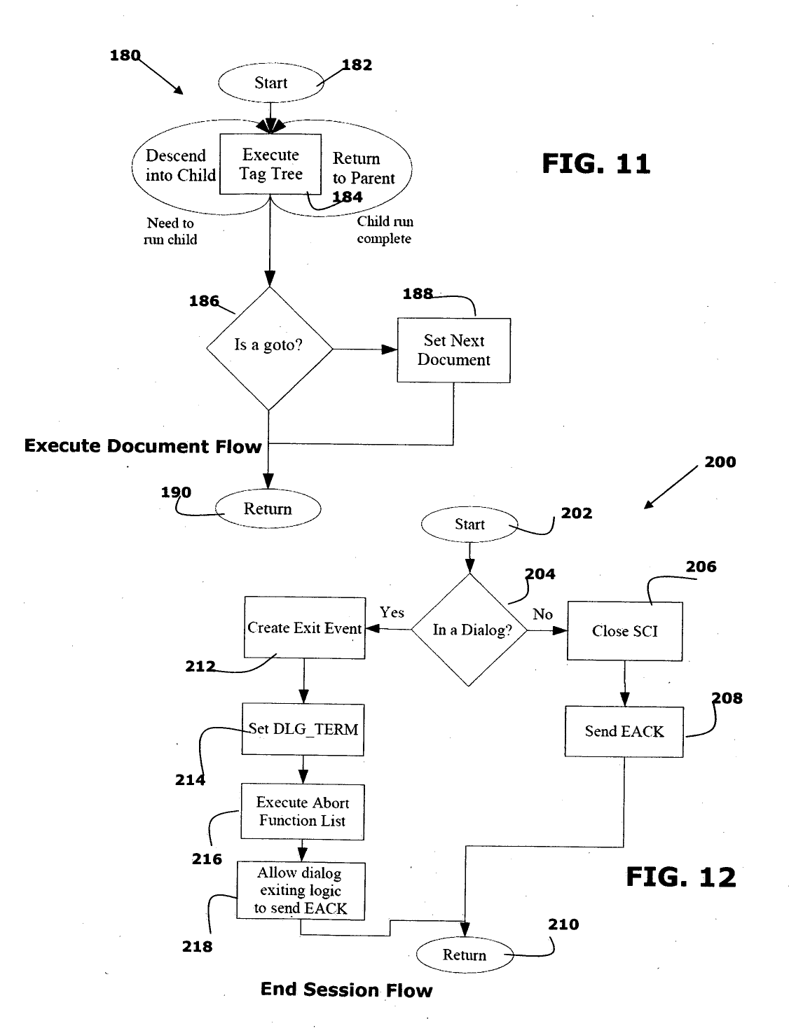

FIG. 11 provides a flow diagram 180 of the execute document flow process of the present embodiment. Beginning at start step 182, execute document flow proceeds to execute Tag tree step 184. Thereafter, if there is the need to run a child object, the process descends to the child level and repeats execute Tag tree step 184. On the other hand, if the child run is complete, then the process returns to the parent level, repeats execute Tag tree step 184, and then proceeds to query 186. At query 186, execute document flow tests whether there is a Go To step. If so, at step 188 process flow 180 sets the next document. Then, the process returns to document execution step 132 (FIG. 8) via return step 190.

FIG. 12 shows the end session flow 200 of one embodiment of the disclosed subject matter. Beginning at start step 202, process flow goes to query 204. At query 204, a test of whether there the process is in a dialog? If not, then process flows to close SCI step 206. From close SCI step 206, process flow goes to send EACK step 210, and then to return step 210. If the process is in a dialog, then process flow goes to execute exit event step 212. From create exit event step 212, process flow goes to set dialog term step 214. At set dialog term step 214 for setting the dialog termination. From dialog term step 214, process flow proceeds to execute abort function list step 216, and then further on to step 218 to allow dialog exiting logic to send the EACK. Then, as before, process flow goes to return step 210.

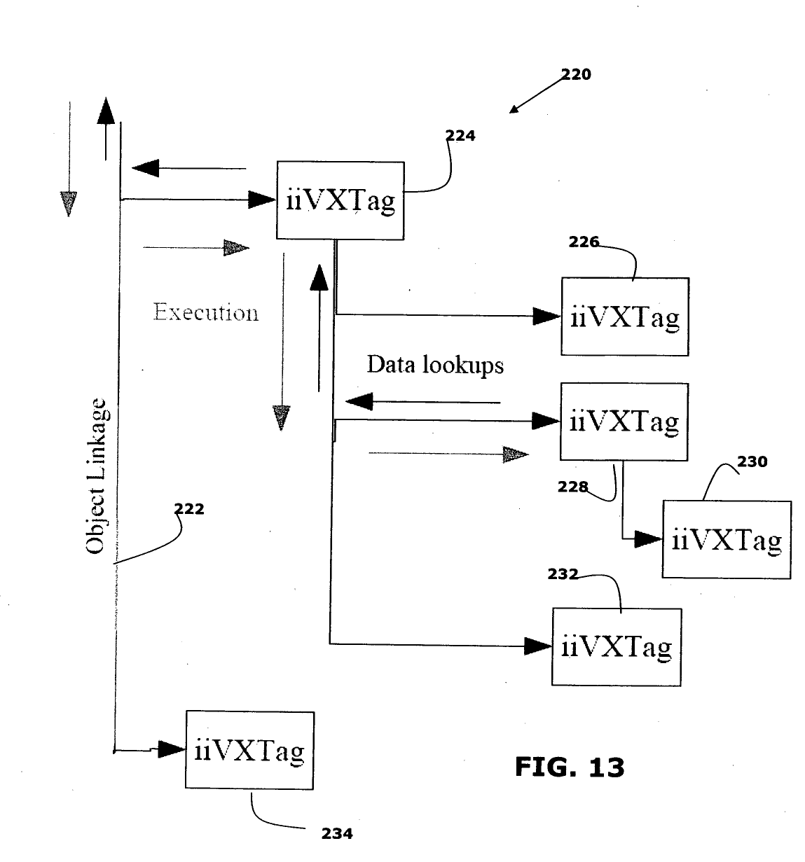

FIG. 13 illustrates one embodiment of the VXTag tree structure 220 of the disclosed subject matter. VXTag tree structure 220 allows for moving up and down the tree, as described in association with FIG. 12. In execution, process flow may proceed along object linkage 222, with execution to VXTag object 224. From VXTag object 224, execution may proceed to VXTag objects 226, 228, and 232, all at the same level. Still further, for example, process execution may proceed from VXTag object 228 to VXTag object 230. In such an execution process, data lookups may be needed. If so, then data lookups may proceed along VXTag tree structure 220 to the appropriate level to obtain the desired data.

The presently disclosed subject matter improves the processing of XML-type documents, including VXML and CCXML documents, in part due to the feature of such documents being parsed only once, unless the document changes. As used herein, the phrase “interpreter” should be understood to include the instance of one channel processing one or more calls. The present embodiment substantially reduces JavaScript® usage during interpreter operations, and compiles document into easily-readable binary format documents, here referred to as VXML binary files. Moreover, the present embodiment converts the VXML binary files to a C++ object tree. The C++ object trees may be traversed at function execution speeds. Also, the present process and system present cache memory functions to processing as close in time to that of instruction execution as possible. The result is an XML-type document processing method and system that processes such documents at many multiples of presently available speeds.

One embodiment of the disclosed subject matter presents an interface between CCXML and VXML processing. For example, when interfaced, call control is no longer in VXML and accepting calls is performed in CCXML. In CCXML call flow, processing is always in a named state, and moving to another call state involves transitioning to another named state. Therefore, a named event that causes the transition of CCXML processing also allows connecting and disconnecting input streams, as well as dial outs. In operation, CCXML processing starts VXML to interact with callers and can terminate the VXML dialogs mid execution. VXML dialogs trigger CCXML state transitions when starting and completing.

The disclosed subject matter, therefore, provides an interactive voice response (IVR) platform including a VXML/CCXML interpreter for interpreting XML-type documents, including VXML and CCXML documents, with efficiencies and speeds heretofore not available. The types of documents the disclosed IVR platform may interpret also includes open systems documents for SQL and other XML services. The present disclosure presents capability, functionality, and flexibility heretofore unavailable in the processing of XML-type documents in a telecommunications network. Moreover, the XML-document processing features here disclosed may find beneficial application well beyond the telecommunications industry.

The embodiment here disclosed partitions call application functionality into functional blocks of a CAPCOM 44 (Call Flow Application Compiler) set of functions, a CX 44(CCXML Proxy Program) set of functions, a CAPER 42 (Call Application Executer) set of functions, JSI (JavaScript® Interface) set of functions, WebSlinger (Web server file Slinger) set of functions, SCIP (Speech Channel Interface Program) set of functions, and DBM (Database Management Program) set of functions.

The disclose method and system provide a VXML flow of execution beginning with the creation of a form, followed by the playing of prompts or gathering of input. presently disclosed objects are supported, and VXML grammar format includes rules and at least one root rule, which may take the following form:

<grammar root=“r”>

<rule id=“r”>

<item>1</item>
<count number=“3+”>

<one-of>

<item>0</item>
<item>1</item>

</one-of>

</count>

</rule>

</grammar>

When passing data from CCXML to VXML, the present embodiment uses variables in CCXML to start a VXML dialog and pass the variables. The VXML document uses appropriate document level variables. These variables may be assigned value from the passed variables. Conversely, when passing data from VXML to CCXML, variables are first in VXML, and processing exits the VXML dialog for passing the variables to CCXML. In the event that the CCXML process includes an appropriate transition handler, the transition occurs and all variables passed back may be referenced with the generally understood “dot” format.

The disclosed IVR platform provides a CCXML/VXML compiler, CAPCOM 44, which is a two-pass compiler. The first pass collects variables from document and creates variable tables and indexes. The second pass replaces variables names with table/index references and uses ID JavaScript® function calls to convert expressions into POSTFIX notation. Also, compilation optimizations are used to solve math problems, use the JSI for actual JavaScript® function calls, and avoid searching for a variable when an indexing operation is possible. The compile tool allows test compilations of CCXML and VXML to validate syntax.

For CCXML execution, execution records (Xrecs) are loaded from a file. Event transitions in the file determine where to begin on specific events. Execution works down Xrecs to the end of a transition. Variable tables store all, variables used, but there is only one variable scope to maintain. During VXML execution, Xrecs are loaded from a file and a multi-branched tree of VXTag objects is created from the Xrecs. Execution works down the tree at C++function call speeds, and returns and exits work back up the tree. The tree also handles advanced scoping issues.

CAPCOM 44, accordingly, provides for the compiling of CCXML and VXML documents to create icompo files. In such processing, requests become events, under the control of IVR platform 20's ARCADE functions. CAPCOM 44 processing includes the use of one of four processes that include (VXML) interpreter functions. The CAPCOM 44 functions operate in conjunction with CAPER 42 set of functions, JavaScript® Interface set of functions, and WebSlinger set of functions to accomplish faster VXML interpretation.

In operation, CAPCOM 44 receives events from CAPER 42, which events contain a file Uniform Resource Locater (URL) of a VXML file that needs to be compiled. CAPCOM 44 then parses that VXML file and creates a binary file 46 containing the compiled result. The output filename is returned to the event originator in an execution acknowledgment (EACK). The binary output file is read-only and can be shared between CAPERs (one CAPER 42 handles one call). The compiled output is more easily processed than the raw VXML, as variable names are already sorted with almost no string processing required during run-time inside CAPCOM 44.

CAPCOM 44 is also used to break away the XML parsing library and XML parsing from multiple CAPERs 42. The legacy XML parsing library processes use a large Xerces library as part of their executable functions. This makes VXRU processes exceedingly difficult to troubleshoot. In addition, in the case where 240 CAPERs may share the same VXML file, a change to that VXML file results in only a single VXML parse and compilation, as opposed to 240 parses which occur under the previous VXRU.

In the event of a process compilation request, CAPCOM 44 compiles a VXML file by first obtaining the file URL from the event. Next, CAPCOM 44 parses the VXML file to generate multiple records into a single output file. CAPCOM 44 output includes sending negative acknowledgment (NEACK) upon failure, or else sending EACK with output filename.

There are no external user interfaces in CAPCOM 44, and no special telephony hardware is required to use CAPCOM 44. CAPCOM 44 is part of A Resource Centric Architecture in a Distributed Environment (ARCADE) third party Red Hat Package Manager (RPM). CAPCOM 44 uses the libXML third party library to parse the XML files. Events are used to communicate with CAPCOM 44 and the core compilation logic exists as a library that can be compiled into command-line test tools. Because excessive use of CAPCOM 44 may require a large amount of CPU, CAPCOM 44 is optimized for high density systems where the VXML files do not change frequently. Any computer that may run CAPCOM 44 requires ARCADE RPMs. CAPCOM 44 may reside inside the Interactive Voice Response (IVR) RPM, placed as one executable program.

The operation of CAPCOM 44 begins when a call lands on an IVR platform wherein the presently disclosed VXML interpreter handles the call flows. The answering CAPER 42 hashes the URL of the answering application into a binary file 46 based on the last modified time of the file. If the hashed binary file 46 exists, CAPER 42 loads it and processes the call. If the hashed binary does not exist, CAPER 42 locates CAPCOM 44 via Distributed Resource Management Architecture (DIRMA) and then requests a compilation via event processing. CAPCOM 44 opens and compiles the VXML and writes out the binary, sending the output filename back CAPER 42. CAPER 42 then loads it and processes the call.

In the above example, there is one CAPER 42 for each call. There can be one or more CAPCOM 44 programs running, although one CAPCOM 44 may service multiple CAPERs and there need not be a one-to-one relationship. Generally, if the VXML files are all URLs that sit on IVR platform 20, there need never be more than one CAPCOM 44. Dynamically changing VXML files and/or off-host URLs are supported, but may require multiple CAPCOMs. In that case, the required ratio of CAPERs to CAPCOMs can only be determined through application tuning and observed performance. The steps of performing CAPCOM 44 functions include first locating CAPCOM 44 via the DIRMA application. Then, the compilation request event may be sent to CAPCOM 44. The process continues with waiting, receiving, and obtaining the compiled filename from the response via CAPCOM 44.

VXML allows for a mixing of mathematical and string processing inside the application. The legacy VXRU handled all of these through JavaScript® calls. The presently disclosed VXML interpreter performs these internally to achieve the benefit of a performance improvement over the legacy library used by the VXRU. CAPCOM 44 must break these expressions down into a series of instructions that can be written to disk for CAPER 42 to process during the call flow.

This is done in three steps. The first step is to build an “infix notation” character string representation of the expression. Infix notation is the common human-readable shorthand for expression parsing. The next step is to turn the infix string into a string more usable to a computer (where parenthesis, order of operations, etc. is factored in as the computer scans the line left to right). The result string of step two is called “postfix notation.” The last step is for CAPCOM 44 to write a series of records to disk for instructing CAPER 42 of the order in which to perform the math through parsing the postfix notation string. CAPCOM 44 replaces numerical constants outside of JavaScript® function calls with variables. CAPCOM 44 then writes records to disk with the assignment values for CAPER 42. Above, CAPCOM 44 records written for CAPER 42 must include an indication that the temporary variables should be evaluated for string length and index respectively.

In the disclosed embodiment, CX 44 or CCXML executor functions involve executing CCXML for call control functions. This process starts VXML document execution and is MOAP controlled. CX 44 presents as a user-controlled interface between call control, switching, conferencing and the presently disclosed VXML interpreter. CX 44 also replaces certain legacy proxy process in IVR platform. CX 44 works in addition to the four other processes of CAPER 42, the JavaScript® Interface or JSI, CAPCOM 44, and the Web file slinger or WebSlinger, to provide a novel VXML and CCXML IVR set of features and functions. There is one CCXML interpreter for every VXML interpreter in the disclosed embodiment.

The disclosed embodiment employs a single process, single thread architecture, however, there may be other architectures, including multi-process, multi-threaded architectures capable of performing the disclosed method. For example, a 248 port IVR may employ the disclosed process so that one the CX UNIX process handles call control, switching, VXML dialog starting and stopping, and conferencing for all 248 channels. In such a configuration, CX 44 may assume the legacy tasks such as Distributed Resource Management (DIRMA) registrations for the call flow applications, publishing of channel status, etc. Massive asynchronicity exists in that CX 44 never blocks on any operation, because it is handling events for multiple channels. This means when it must wait for an event response before proceeding while processing one channel's current document, it uses a combination of callback data, event response registrations and timeouts to avoid holding up processing for other channels.

An example of this asynchronicity feature appears in the create conference element. This element is supposed to return the conference ID. However, integration may require waiting for the event response from the Speech Channel Interface (SCI) before obtaining the conference ID. As a result, we register for that response, create callback data etc and go back to processing other channels while we wait for the conference ID to come back, at which point we assign the ID in the requesting document and proceed.

CX 44 can run independent of CAPER 42 to provide the benefit of appearing during CCXML application development and maintenance. For example, a CCXML document can accept calls, bridge calls, create conferences, place calls in conferences, etc. However, it cannot collect digits, verify pin numbers, or play prompts.

In operation, the interval for application recompiling may be established by CX 44. For example, CX 44 checks for default document changes at a 1 Hz rate for local URLs. A 15-second interval is used for off-host URLs. CX 44 is an event driven program that can be described as a communications hub, event blaster, and parser of compiled CCXML applications. CX 44 uses several existing components from ARCADE), such as the following:
a debug component that writes debug info to /interact/logs/. There is one debug file per CX 44 channel, and a single separate file for channel independent specific information;
a component for writing to exception logs;
a component for timing and socket notification;
an event component and manager for sending and receiving events;
an interface with Master of All Processes(MOAP);
a registration resource for registering call flow programs w/DIRMA, identifying CX 44 as the owner, and allowing for call control programs to see CX 44;
a data tag whereby CX 44 reports items such as last reset time, channel status for Status and Control (STATCON), number of channels off hook, etc.;
a template container class that holds metadata about each channel, each active connection, etc.;
a status class that is used by CX 44 and CAPER 42 to set and retrieve channel status for STATCON;
a CCXML document class that contains CCXML document specific information and the logic to parse the compiled document;
many different types of compiled X record (Xrec) classes are used to read the compiled output from disk (these records are the written output of CAPCOM 44 process); and
a variable manager class used to store, retrieve, and compute all the mathematical operations on variables from the CCXML document.

Execution in CX 44 begins with initialization, including opening debug for channel independent reporting. Creating container classes for connections, free call IDs, etc. occurs next. Then, creating a single reactor class may occur. Parsing command line arguments and starting up CX 44 status may then occur. CX 44 then locates web resource, compiler resource, and JSI resource. Compiling default documents then occurs if running without VXML. In the execution of VXML documents, CAPERs may have already compiled their default document (a CCXML document). Registering for events and defining data tags also takes place.

The system architecture for CX 44 includes a main loop performing a set of functions. These functions may include waiting for the reactor class to show event received, receive and process event. A series of waking steps may then occur as follows: (a) wake up every 30 seconds and report call flow resource to DIRMA; (b) wake up once a second and request a recompile of any file default document if necessary; (c) wake up once every 15 seconds and request a recompile of any default http documents; and (d) wake up once a second and flush debug, advisory, and tags.

Interfaces used by CAPCOM 44 and other programs include a CX-to-DIRMA interface, whereby CX 44 uses a C++ wrapper to send events to DIRMA and the CX-to-the CAPER interface to exchange data between the CCXML and VXML interpreters. CX 44 sends a dialog start command to the VXML interpreter as the result of encountering a dialog start element. The Specification has no concept of a SCID-like entity (e.g., a vendor hardware voice channel). As a result, the required switch connection between voice channel/SCID and the inbound Public Switched Telephone Network (PSTN) of IP network (e.g., for Voice of IP (VoIP) calls) call is done by CAPER 42 after the first dialog start for each call.

CX 44 receives the events from call control layers or off-hook triggers such as PSTN, VoIP, AUTO START, and CRON. It then runs the default CCXML application for the assigned channel. The result of that document processing would be additional events sent back to the call control layers and/or the VXML session for the answering CCXML channel. CX 44 also takes care of the mundane ARCADE tasks for all the VXML sessions such as Distributed Resource Management (DIRMA) loading, hook state reporting to the Data Tag Server, etc. No special telephony hardware is required to use CX 44. All software interfaces are supported by installation of the presently disclosed Red Hat Package Manager (RPM) files. CX 44 may reside inside the Interactive Voice Response (IVR) RPM.

In operation of CX 44, a call may land on an IVR platform with the VXML/CCXML interpreter handling the call flows. The call control layer sends a PSTN_OFFER to CX 44, which picks a free CCXML channel to handle the call. The PSTN_OFFER event generates an internal connection ALERTING event inside CX 44 and is sent to the default document. A <transition> element exists in the document for that event and state which EACKs the PSTN_OFFER via an <accept> and then starts a VXML document via a <dialog start> element. In the above example, there is one span manager component and one CX 44 process running (generally, there may only ever be one CX 44 process running). CX 44 can support any number of CCXML channels due to its use of compiled output documents.

The steps that allow use of CX 44 include the following. First, there is the step of locating the CX/VRU resource via the Distributed Resource Management Architecture (DIRMA). The next step is to send the event to CX 44 (auto_start, call offer, etc), following by the steps of waiting for, receiving, and processing the response from CX 44.

Typically an inbound call may contain a SCI identification that is owned or requested by CAPER 42. The CAPER may pass this SCID to CX 44 on the dialog exit event. CX 44 needs this information for conferencing, and in bridge calls to allow the inbound side to transmit to his voice channel. In this example CAPER 42 “owns” the SCID and may release it upon receiving the dialog end session event. In addition, an inbound call may be dumped immediately into a conference and to bypass any VXML. Using vendor hardware telephony interfaces, the inbound call is to be obtained and be full duplex switched to its voice channel before the <join> into the conference is flagged as successful via the CCXML joined variable. In this example, CX 44 does this SCID request and full duplex switch and thus “owns” the SCID and would release it at end call.

CX 44 may replace the ARCADE proxy processor IVR platforms, with the proxy served as the “proxy interface” between span managers (call control) and voice response units (VRU). CX 44 may perform the same functionality but driven by CCXML applications to perform that task. With a CCXML driven IVR, inbound calls may first encounter a CCXML document, which may accept or reject the call, start a VXML document to begin processing, create a conference, dial out, and switch calls together etc.

Another aspect of the disclosed subject is the CAPER or Call Application Executor, which executes VXML documents and is used by CX 44. CAPER 42 is controlled by MOAP and performs XML parsing and compilation, if the VXML files have changed from the previous compilation. CAPER 42, therefore, is one of five processes that works in conjunction with the JavaScript® Interface, CX 44, CAPCOM 44, and the WebSlinger to accomplish faster VXML execution. The CAPER receives events that cause it to retrieve via WebSlinger, compile via CAPCOM 44, and execute VXML documents. These documents accept input from the caller, play messages, and record messages. There is no direct hardware interface in CAPER 42. All interfaces are event driven. The CAPER interface, therefore, is an event mechanism contained in a library that is part of an ARCADE RPM package. The CAPER may reside inside IVR platform 20's RPM. It may get placed as one executable inside/interact/program.

In the operation of CAPER 42, a call lands on an IVR with the VXML interpreter handling the call flows. The span manager sends a PSTN_OFFER event to a CCXML channel, which in turn sends a dialog start event to CAPER 42. The CAPER sends a CAPCOM COMPILE event to CAPCOM 44, which returns a binary file 46 on disk. CAPER 42 reads in the binary and sends a SCI_PLAYFILE_START to the Speech Channel Interface (SCI). The SCI sends a SCI_PLAYFILE_DONE event back to CAPER 42, which then sends a dialog disconnect event to CX 44, which in turn sends a PSTN_HANGUP event to the Span Manager. There is at least one CAPER 42 per timeslot. There is one CX, one SCI, and at least one CAPCOM 44 in the example mentioned.

Steps to be followed to use the component, include sending an off-hook event to CCXML, followed by having the CCXML document send a dialog start event to CAPER 42. CAPER 42 preferably functions on the same OS as the rest of the IVR software and should conform to the finalized VXML 2.0 specification. Also, CAPER 42 may use the standard ARCADE event and DIRMA interfaces. CAPER 42 executes VXML applications which have been compiled by CAPCOM 44. CAPER 42 is also a single threaded process in the present embodiment. Accordingly, for support of multiple simultaneous VXML applications, the desired number of CAPER 42 processes must be started. The CAPER supports JavaScript® via the JSI application's event interface. Also, CAPER 42 supports HTTP access via the WebSlinger application's event interface. The present embodiment divorces CAPER 42 from vendor hardware in that CAPER 42 does not interact with any vendor level APIs.

Speech/Prosody functionality exists with CAPER 42, which supports a speech control processor application event interface. Also, CX 44 controls and reacts to changes in the call state, while CAPER 42 reacts to CX 44 directives which are in the form of interface events. The CAPER uses a default CCXML application to start up. This application is the CCXML document that CX 44 uses to control this DIRMA group. VXML is executed when a CCXML document starts a dialog. The CAPER also uses a DIRMA name to start up. Since multiple CAPER processes may be started, there may be multiple DIRMA groups. The CAPER also may provide conference capabilities pertaining to volume and prompt playback. Moreover, CX 44 enables conference creation, joining, leaving, and destruction capability.

The disclosed IVR platform also provides a JSI or JavaScript® Interface for executing JavaScript® code and for returning values as needed. For the JSI, requests are events in a MOAP controlled environment. The WebSlinger functions enable an HTTP interface for ARCADE, that performs Get and Post operations. The JSI has caching capability built-in. Here, also, requests are events and responses contain location of file. Also, WebSlinger functions are MOAP controlled.

The WebSlinger provides an interface to web protocols (e.g., HTTP) via the event functionality. An ARCADE process needing access to files on a web server may use the simpler event class rather than incorporating libraries to perform web access itself. The WebSlinger is a part of the presently disclosed VXML interpreter. VXML/CCXML processing includes access to URL based files which may be off host. WebSlinger offers this functionality without placing web libraries in each process.

WebSlinger, therefore, provides a means for getting files from and putting files to a web server. These functionalities preferably constitute a complete transaction in a request and response pair. WebSlinger may be usable by any process needing to use HTTP to access a file on a web server. The CAPCOM 44 process is directed to compile a VXML document via a URL. The URL points to a webserver and file.

WebSlinger enables ARCADE processes access via the event technology to files on a web server through HTTP protocols. Using the event functionality to communicate, an ARCADE process does not need to contain the logic to perform the actual HTTP communication. WebSlinger operates as an event request processor. A process needing a file from a web server sends a request to WebSlinger containing the target URL. This URL is used to perform the HTTP request. Once the transfer is complete, WebSlinger sends a response event containing the location of the collected file. WebSlinger also contains the capability to store retrieved files in a caching system, such that future requests for the unchanged file may not incur the time and network resource penalty such as often occurs in the event of a full request.

WebSlinger is installed and run on a standard ARCADE system. Future interface modifications are allowed for by adding new event requests and associated handler functions. Performance of the WebSlinger is largely based on external factors. If the web server or network is slow, WebSlinger may take an extended period of time to respond with the requested file. Requesting applications must be prepared for files to take time to be retrieved. While the requesting application may timeout on a request, the WebSlinger may continue the retrieval process and send the response when it is finished. Since WebSlinger makes use of available disk space for caching, it also performs cache directory cleanup operations.

One embodiment of WebSlinger performs the recurring cleanup sweep. An interface event is available to trigger the cleanup. This event may be sent to any WebSlinger instance which may then perform the cleanup. CAPCOM 44 creates an event GET request and populate it with the URL for the file. CAPCOM 44 performs a DIRMA lookup to find an available WebSlinger. CAPCOM 44 then sends this request to the WebSlinger. CAPCOM 44 waits for a response event to return from the WebSlinger. WebSlinger receives the request and begin processing. WebSlinger identifies if the file is cacheable and if it is cached. If the file is cacheable and cached, WebSlinger verifies it is up to date with the web server. If the file is up to date, WebSlinger responds to the request with location of the cached file (EACK).

If the file is cacheable and not cached, WebSlinger retrieves the file, places it into the cache, and returns the location of the cached file (EACK). If the file is not cacheable, WebSlinger retrieves the file, places it in a requesting process specific location, and returns the location of the file (EACK). If an error occurs while retrieving the file, WebSlinger may respond with the error information (NEACK). CAPCOM 44 then makes use of the file.

WebSlinger performs HTTP Get and Post operations using nonblocking sockets. This allows WebSlinger to process multiple transactions simultaneously. Caching takes place in the web cache associated with IVR platform 20. Files names are created from the URL where all invalid characters are altered to underscores. HTTP headers are stored with the same name as the data file followed by “.webhead”. Files that cannot be cached (i.e. Resulting from POST operations) need to be stored on disk for hand off to another application. Filenames take the same format as a cacheable file. Cache cleanup may be performed on a configurable interval specified in the MOAP configuration file. Maximum file age is configurable in the MOAP configuration as well. When cache cleanup is performed, all expired files are removed.

The HTTP protocol offers several request methods and header entries. The functionality of WebSlinger is broken out into objects for the following tasks: caching, domain name service (DNS), HTTP Header receiving, HTTP header sending, HTTP requests, and MOAP process interfacing WebSlinger makes use of the HEAD request to first gather data about the item being requested for a GET operation. This allows caching to be performed. WebSlinger makes use of the GET request to gather data from the file. WebSlinger makes use of the POST request to append extra header data to the request for advanced transactions with the web server. Other embodiments may include FTP support and HTTPS support.

Yet another aspect of the disclosed IVR platform includes a SCIP or Speech Control Interface Process that enables access to vendor speech applications and offers conferencing capabilities. In such process, requests are events, all of which are MOAP controlled. SCIP provides a generic event interface for performing speech operations. Speech library linkage is kept out of other processes and may deal with DSP loading issues. Also, new vendor speech libraries can be implemented in a new SCIP process with the same interface.

The disclosed subject matter also includes a DBM or Database Manager for database access via SQL that may run on a gdbm library. The limited SQL usage on gdbm exists, wherein requests are events, and which are MOAP-controlled. With the disclosed subject matter also are enabled INSA features, wherein ELN queries are configurable on field, filtering, and ordering. Users may login and be limited by account access to levels, for example of read-only, read-write, and administrator. Users may also save queries to their local machine, such as ISIS features new ISUP statistics screen. ELN logging may be configured at install to send logging to an off host database via odbc. Logging also may go to local text log file. Notification may occur through phone, fax, pager, and email notification that is configured through INSA.

In essence, therefore, the disclosed subject matter, in a streamlined architecture, provides a novel IVR platform with maximum performance including RPM technology processes for error-free software delivery and installation tools providing reduced manual post-installation configuration. Built for increasing the speed of processing VXML and CCXML documents, the disclosed subject matter has significantly less reliance on third party software than do similar IVR software systems. Specific features of the disclosed IVR platform include the ability to offer prepaid services in a hardware break-away architecture capable of supporting VXML and CCXML document parsing.

The services made possible through the present embodiment include prompt playback/record, facsimile transmission support, and conferencing functions such as on-demand and “meet-me’ conferencing.

Application controlled stream switching is possible with the disclosed IVR platform, as well as database functions. Furthermore, ISIS, ELN, and INSA are made possible through the disclosed IVR platform. Because the disclosed IVR relies less on third-party software systems, the functions of its various applications may be run on a separate system than the hardware. This permits multiple XAP (XML Application) servers to operate, for example, a single audio call and switch or ACS server for serving multiple telecommunications networks.

The hardware break-away features of the present system include the ability to separate application execution from call control. VXML/CCXML operate on an XML Application (XAP) system and call boards and drivers operate on a separate ACS system. There are only minor or no modifications needed to the software in order to add new hardware to IVR platform 20. Conversely, a software break-away is also enabled by the disclosed subject matter. The present software break-away provides the ability to offer the VXML/CCXML interpreters as a stand-alone product.

The JavaScript® Interface is one of four processes that include presently disclosed Voice Extended Markup Language (VXML) interpreter. The JavaScript® Interface works in conjunction with CAPER 42, CAPCOM 44, and WebSlinger to accomplish faster VXML document execution. The JavaScript® Interface receives events containing JavaScript® functions and function arguments. It then uses the JavaScript® Library APIs to compile and/or execute the script with any supplied arguments, returning the result in an execution acknowledgment (EACK). Typically, these scripts and calls to the script functions may be made by CAPER 42 as it encounters script calls present in a VXML driven call flow. JavaScript® Interface is required to divorce the JavaScript® Library from the multiple CAPERs. In contrast, the legacy VXRU would often core dump inside the JavaScript® library, resulting in a difficult-to-troubleshoot set of set of instructions and associated data. With at least one CAPER 42 running per timeslot on an IVR, there may also be a memory savings.

Excessive use of JavaScript® or the JavaScript® Library may use a large amount of CPU. The presently disclosed interpreter internalizes JavaScript® functionality as much as possible inside CAPER 42, for flow control, arithmetic, variables, etc. This leaves JavaScript® function calls to be handled by JavaScript® Interface. Communication with JavaScript® Interface—and in reality, with JavaScript® itself-should be kept to a minimum during call flow design.

In operation, a call lands on an IVR platform with the presently disclosed VXML interpreter handling the call flows. The answering application encounters a JavaScript® function call inside its VXML document. The CAPER then sends the required information to JavaScript® Interface, which calls the JavaScript® Library API to compile, execute, and return the result. JavaScript® Interface then sends the event response to CAPER 42, which proceeds down its call flow.

In the above example, there is one CAPER 42 for each call. There can be one or more JavaScript® Interface programs running, although one JavaScript® Interface shall be able to service multiple CAPERs—there need not be a one-to-one relationship. The required ratio of CAPERs to JavaScript® Interfaces can only be determined through application tuning and observed performance.

Steps that need to be followed to use the component include locating the JavaScript® Interface via the Distributed Resource Management Architecture (DIRMA), and then sending the event to JavaScript® Interface. Thereafter, use of JavaScript Interface involves waiting, receiving, and processing the response from JavaScript® Interface.

The processing features and functions described herein can be implemented in various manners. For example, not only may DSP 40 perform the above-described operations, but also the present embodiments may be implemented in an application specific integrated circuit (ASIC), a micro controller, a microprocessor, or other electronic circuits designed to perform the functions described herein. The foregoing description of the preferred embodiments, therefore, is provided to enable any person skilled in the art to make or use the claimed subject matter. Various modifications to these embodiments may be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method for processing VXML documents in association with the operation of a telecommunications network, comprising the steps of:
parsing a VXML document a single time for all instruction execution relating to said VXML document for generating a VXML reference document;
compiling said VXML reference document for generating a VXML binary reference file comprising a plurality of binary data sets derived from said VXML reference document;
converting said VXML binary reference file to an object tree for use of the contents of said VXML binary reference file at essentially execution speeds;
storing data in a cache memory, said data relating to said VXML binary reference file at a point essentially approximating the execution point of said data in the processing of said VXML document; and
executing instructions for the processing of said VXML document using said data and said VXML binary reference file.

2. The method of claim 1, further comprising the step of converting said VXML binary reference file to a C++object tree.

3. The method of claim 1, further comprising the step of performing said VXML processing in a predetermined XML Application (XAP) circuit for processing said VXML document at location separable from said telecommunications network.

4. The method of claim 1, further comprising the step of using a call application executor circuit for parsing said VXML document.

5. The method of claim 1, further comprising the step of using a call application compiler for compiling said VXML reference document.

6. The method of claim 1, further comprising the steps of:
parsing a CCXML document a single time all processing of said CCXML document and generating a CCXML reference document; and
compiling said CCXML document into a CCXML binary reference filing using a call application compiler.

7. The method of claim 1, further comprising the step of controlling said VXML document processing using a set of master of all processing interface instructions.

8. The method of claim 1, further comprising the step of processing JavaScript® instructions relating to said VXML reference document using a JavaScript® interface means.

9. The method of claim 1, further comprising the step of performing get and post operations relating to said VXML document processing using an HTTP interface means.

10. The method of claim 1, further comprising the step of performing get and post operations relating to said VXML document processing using an HTTP interface means.

11. The method of claim 1, further comprising the step of performing speech processing operations relating to said VXML document processing using a speech control interface means.

12. The method of claim 1, further comprising the step of performing database management operations relating to said VXML document processing using a database management means.

13. A system for processing XML-type documents in association with the operation of a telecommunications network, comprising:
parsing circuitry for parsing a VXML document a single time for all instruction execution relating to said VXML document for generating a VXML reference document;
compiling circuitry for compiling said VXML reference document for generating a VXML binary reference file comprising a plurality of binary data sets derived from said VXML reference document;
binary conversion circuitry for converting said VXML binary reference file to an object tree for use of the contents of said VXML binary reference file at essentially execution speeds;
a cache memory associated with said parsing circuitry storing and providing access to data relating to said VXML binary reference file at a point essentially approximating the execution point of said data in the processing of said VXML document; and
execution circuitry for executing instructions for the processing of said VXML document using said data and said VXML binary reference file.

14. The XML-type document processing system of claim 13, further comprising circuitry for converting said VXML binary reference file to a C++ object tree.

15. The XML-type document processing system of claim 13, further comprising circuitry for performing said VXML processing in a predetermined XML Application (XAP) circuit, said XAP circuit for processing said VXML document at location separable from said telecommunications network.

16. The XML-type document processing system of claim 13, further comprising a call application executor circuit for parsing said VXML document.

17. The XML-type document processing system of claim 13, further comprising a call application compiler for compiling said VXML reference document.

18. The XML-type document processing system of claim 13, further comprising:
parsing circuitry for parsing a CCXML document a single time all processing of said CCXML document and generating a CCXML reference document; and
compiling circuitry for compiling said CCXML document into a CCXML binary reference filing using a call application compiler.

19. The XML-type document processing system of claim 13, further comprising a master of all processing interface circuit for controlling said VXML document processing system.

20. The XML-type document processing system of claim 13, further comprising a JavaScript® interface means for processing JavaScript® instructions relating to said VXML reference document.

21. The XML-type document processing system of claim 13, further comprising an HTTP interface means for performing get and post operations relating to said VXML document processing.

22. The XML-type document processing system of claim 13, further comprising a speech control interface means for performing speech processing operations relating to said VXML document processing.

23. The XML-type document processing system of claim 13, further comprising a database management means for performing database management operations relating to said VXML document processing.

24. A telecommunications system for processing XML-type telecommunications documents, comprising an XML-type document processing circuit, said XML-type document processing circuit comprising:
means for parsing a VXML document a single time for all instruction execution relating to said VXML document for generating a VXML reference document;
means for compiling said VXML reference document for generating a VXML binary reference file comprising a plurality of binary data sets derived from said VXML reference document;
means for converting said VXML binary reference file to an object tree for use of the contents of said VXML binary reference file at essentially execution speeds;
means for associating a cache memory with said parsing means for storing and providing access to data relating to said VXML binary reference file at a point essentially approximating the execution point of said data in the processing of said VXML document; and
means for executing instructions for the processing of said VXML document using said data and said VXML binary reference file.

25. The telecommunications system of claim 24, further comprising means for converting said VXML binary reference file to a C++ object tree.

26. The telecommunications system of claim 24, further comprising means for performing said VXML processing in a predetermined XML Application (XAP) circuit, said XAP circuit for processing said VXML document at location separable from said telecommunications network.

27. The telecommunications system of claim 24, further comprising call application executor means for parsing said VXML document.

28. The telecommunications system of claim 24, further comprising call application compiler means for compiling said VXML reference document.

29. The telecommunications system of claim 24, further comprising:
means for parsing a CCXML document a single time all processing of said CCXML document and generating a CCXML reference document; and
means for compiling said CCXML document into a CCXML binary reference filing using a call application compiler.

30. The telecommunications system of claim 24, further comprising means for controlling said VXML document processing in association with a master of all processing interface circuit.

31. The telecommunications system of claim 24, further comprising a JavaScript® interface means for processing JavaScript® instructions relating to said VXML reference document.

32. The telecommunications system of claim 24, further comprising an HTTP interface means for performing get and post operations relating to said VXML document processing.

33. The telecommunications system of claim 24, further comprising a speech control interface means for performing speech processing operations relating to said VXML document processing.

34. The telecommunications system of claim 24, further comprising a database management means for performing database management operations relating to said VXML document processing.

35. A computer usable medium having computer readable program code means embodied therein for operation in association with a telecommunications system for processing XML-type telecommunications documents, the computer usable medium comprising:
computer readable program code means for parsing a VXML document a single time for all instruction execution relating to said VXML document for generating a VXML reference document;
computer readable program code means for compiling said VXML reference document for generating a VXML binary reference file comprising a plurality of binary data sets derived from said VXML reference document;
computer readable program code means for converting said VXML binary reference file to an object tree for use of the contents of said VXML binary reference file at essentially execution speeds;
computer readable program code means for associating with a cache memory and said parsing code means in storing and providing access to data relating to said VXML binary reference file at a point essentially approximating the execution point of said data in the processing of said VXML document; and
computer readable program code means for processing of said VXML document using said data and said VXML binary reference file.

36. The telecommunications system of claim 24, further comprising:
computer readable program code means for parsing circuitry for parsing a CCXML document a single time all processing of said CCXML document and generating a CCXML reference document; and
computer readable program code means for compiling said CCXML document into a CCXML binary reference filing using a call application compiler.
